(19) United States
(12) Patent Application Publication
(10) Pub. No.: US 2017/0014785 A1
(43) Pub. Date: Jan. 19, 2017

(54) SYSTEMS AND METHODS FOR AN AUTOMATED VENDING MACHINE FOR BLENDING CUSTOMIZED DRINKS OR MEALS

(71) Applicants: William CHILDERS, Campbell, CA (US); Kyle Foletta, San Diego, CA (US)

(72) Inventors: William CHILDERS, Campbell, CA (US); Kyle Foletta, San Diego, CA (US)

(21) Appl. No.: 15/209,706

(22) Filed: Jul. 13, 2016

Related U.S. Application Data
(60) Provisional application No. 62/191,954, filed on Jul. 13, 2015.

(51) Int. Cl. B01F 3/12; B01F 7/16; B01F 15/00; B01F 13/10; B01F 13/00

(52) U.S. Cl. CPC B01F 3/1221; B01F 13/1055; B01F 13/0016; B01F 15/00025; B01F 7/1605; B01F 2215/0014; B01F 2215/0022

(57) ABSTRACT

An apparatus has a container conveyor configured to transport a container to locations within the apparatus. The locations include a liquid station comprising a liquid source configured to dispense a liquid to the container, an additive station comprising an additive source configured to dispense an additive to the container, a distribution station accessible to a user and configured to receive the container, and a blending station separate from the liquid station, the additive station, and the distribution station. The blending station includes a blending mechanism configured to blend, in the container, the liquid and the additive to form a mixture. The blending station also has a cleaning chamber with a cleaning mechanism configured to clean remains of the mixture from the blending mechanism and the cleaning chamber.

### RELATED APPLICATION(S)

This application claims the benefit of U.S. Provisional Application No. 62/191,954, filed Jul. 13, 2015, titled “Systems and methods for an automated vending machine for blending customized drinks or meals,” which is hereby incorporated by reference in its entirety.

### TECHNICAL FIELD

The subject matter described herein relates generally to creating customized drinks or meals in an automated vending machine.

### BACKGROUND

Vending machines allow a user to select from a number of items which the vending machine then dispenses. Some vending machines, such as coffee machines or cocoa machines, prepare the item in the machine and then dispense the prepared item to the user. Other vending machines dispense pre-made food or drink items according to user's selection.

### SUMMARY

In one aspect, an apparatus has a container conveyor configured to transport a container to locations within the apparatus. The locations include a liquid station comprising a liquid source configured to dispense a liquid to the container, an additive station comprising an additive source configured to dispense an additive to the container, a distribution station accessible to a user and configured to receive the container, and a blending station separate from the liquid station, the additive station, and the distribution station.

The blending station includes a blending mechanism configured to blend, in the container, the liquid and the additive to form a mixture. The blending station also has a cleaning chamber with a cleaning mechanism configured to clean remains of the mixture from the blending mechanism and the cleaning chamber.

In some variations, the cleaning mechanism can have a cleaning solution source configured to deliver a cleaning solution to the cleaning chamber and an ultraviolet light source configured to expose the blending mechanism to ultraviolet light.

In other variations, the blending mechanism can have a blending element shaped to be inserted into the container for blending the mixture. The blending mechanism can be configured to vertically translate a blending element to bring the blending element into an interior region of the container during blending.

In other variations, the cleaning mechanism can be configured to clean remains of the mixture from an interior surface of the cleaning chamber.

In yet another variation, the container conveyor can be configured to move the container on a horizontal plane connecting the locations.

In another variation, the blending station can be vertically aligned and separate from the cleaning chamber. Also the apparatus can be configured to vertically translate the blending element to bring the blending element into the cleaning chamber.

In another variation, the additive can be a powder and the liquid can be water.

In yet another variation, a user interface can be configured to receive instructions from a user selecting a type of additive, where a processor in the apparatus is configured to transmit commands to the container conveyor, the liquid station, the additive station, and the blending station to create the mixture according to the type of additive selected.

In an interrelated aspect, a method includes: translating, with a container conveyor, a container to a liquid station, first dispensing, with a liquid source, a liquid to the container in the liquid station, second translating, with the container conveyor, the container to an additive station, second dispensing, with an additive source, an additive to the container in the additive station, third translating, with the container conveyor, the container to a blending station, blending, with a blending element operatively connected to a blending mechanism in the blending station, the liquid and the additive to form a mixture, and cleaning, with a cleaning mechanism in a cleaning chamber, the blending element.

In some variations, the method can include exposing the blending mechanism to ultraviolet light from an ultraviolet light source in the cleaning mechanism.

In other variations, the method can include inserting a blending element, operatively connected to the blending mechanism, into the container, and blending the mixture in the container with the blending element.

In other variations, the translating can be on a horizontal plane connecting the locations.

In yet other variations, the method can include vertically translating the blending element to bring the blending element into the cleaning chamber, cleaning an interior surface of the blending station and the blending element with the cleaning mechanism, and vertically translating the blending element to bring the blending element into an interior region of the container during blending.

In an interrelated aspect, a user interface can be configured to receive instructions from a user, of a selection of a type of beverage comprising a liquid and an additive. The container conveyor can be controlled to translate a container to a liquid station, an additive station, and a blending station, during creation of the mixture according to the type of beverage selected. The controlling can include translating, with a container conveyor, a container to a liquid station, first dispensing, with a liquid source, a liquid to the container in the liquid station, second translating, with the container conveyor, the container to an additive station, second dispensing, with an additive source, an additive to the container in the additive station, third translating, with the container conveyor, the container to a blending station, blending, with a blending element operatively connected to a blending mechanism in the blending station, the liquid and the additive to form a mixture, and cleaning, with a cleaning mechanism in a cleaning chamber, the blending element.

In some variations, the cleaning can include vertically translating a blending element, operatively connected to a cleaning mechanism, to bring the blending element into a cleaning chamber, cleaning the blending element and an interior surface of the cleaning chamber with the cleaning mechanism, the cleaning mechanism comprising a pressurized water source, and exposing the blending mechanism to ultraviolet light from an ultraviolet light source in the cleaning mechanism.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a perspective view of an exemplary automated vending machine in accordance with certain aspects of the present disclosure;

FIG. 2 is a perspective view of the exemplary automated vending machine in accordance with certain aspects of the present disclosure;

FIG. 3 is top elevational view of the exemplary automated vending machine in accordance with certain aspects of the present disclosure;

FIG. 4 is a side elevational view of the exemplary automated vending machine in accordance with certain aspects of the present disclosure;

FIG. 5 is a perspective view of an X-axis shelf in accordance with certain aspects of the present disclosure;

FIG. 6 is a perspective view of a Y-axis moving plate in accordance with certain aspects of the present disclosure;

FIG. 7 is an exploded perspective view of container holder in accordance with certain aspects of the present disclosure;

FIG. 8 is an exploded perspective view of an additive source in accordance with certain aspects of the present disclosure;

FIG. 9 is a perspective view of an additive source array in accordance with certain aspects of the present disclosure;

FIG. 10 is a perspective view of a blending station and cleaning chamber in accordance with certain aspects of the present disclosure;

FIG. 11 is a front elevational view of the blending station and cleaning chamber in accordance with certain aspects of the present disclosure;

FIG. 12 is a side elevational view of the blending station and cleaning chamber in accordance with certain aspects of the present disclosure;

FIG. 13 is a simplified diagram illustrating a container at the blending station in accordance with certain aspects of the present disclosure;

FIG. 14 is a simplified diagram illustrating a blending element in the container during the blending process in accordance with certain aspects of the present disclosure;

FIG. 15 is a simplified diagram illustrating the blending element at a cleaning chamber in accordance with certain aspects of the present disclosure; and

FIG. 16 is a diagram illustrating operations of a computer-program product in accordance with certain aspects of the present disclosure.

### DETAILED DESCRIPTION

As used herein, “automated vending machine” is defined to refer to any sort of apparatus that prepares and dispenses a beverage, food, or other product to a user. The term “vending machine” does not require any structure or function not expressly described by this disclosure. Similarly, the term “automated” does not require any particular operation or combination of operations to be automated. Specifically, some features described herein can be performed or initiated by a user.

As used herein, the term “mixture” and “beverage” is defined to generally refer to the drink, food, snack, meal, or other product prepared by the automated vending machine. Mixtures or beverages can include, for example, pre-workout drinks, fresh or dried fruits or vegetables, ice, or the like. The mixture or beverage can include any combination of ingredients dispensable by the automated vending machine or added by the user. The mixture or beverage can also, in some circumstances, contain only a single component and thus should not be construed to contain any particular number or type of constituent ingredients.

An automated vending machine can be used to dispense a variety of beverages to a user. As described herein, the automated vending machine can allow a user to select a type of beverage to be dispensed. Once selected, a container can be translated to stations throughout the automated vending machine where water or additives can be added as ingredients to the beverage. Once the ingredients are added, the container can be moved to a blending station where a blending apparatus can blend the ingredients into a mixture to form the beverage. The beverage can then be translated to a distribution station where the user can take the beverage. After the beverage has left the blending station, part of the blending mechanism, including a blending element, can be moved to a cleaning chamber. There, the blending element can be cleaned.

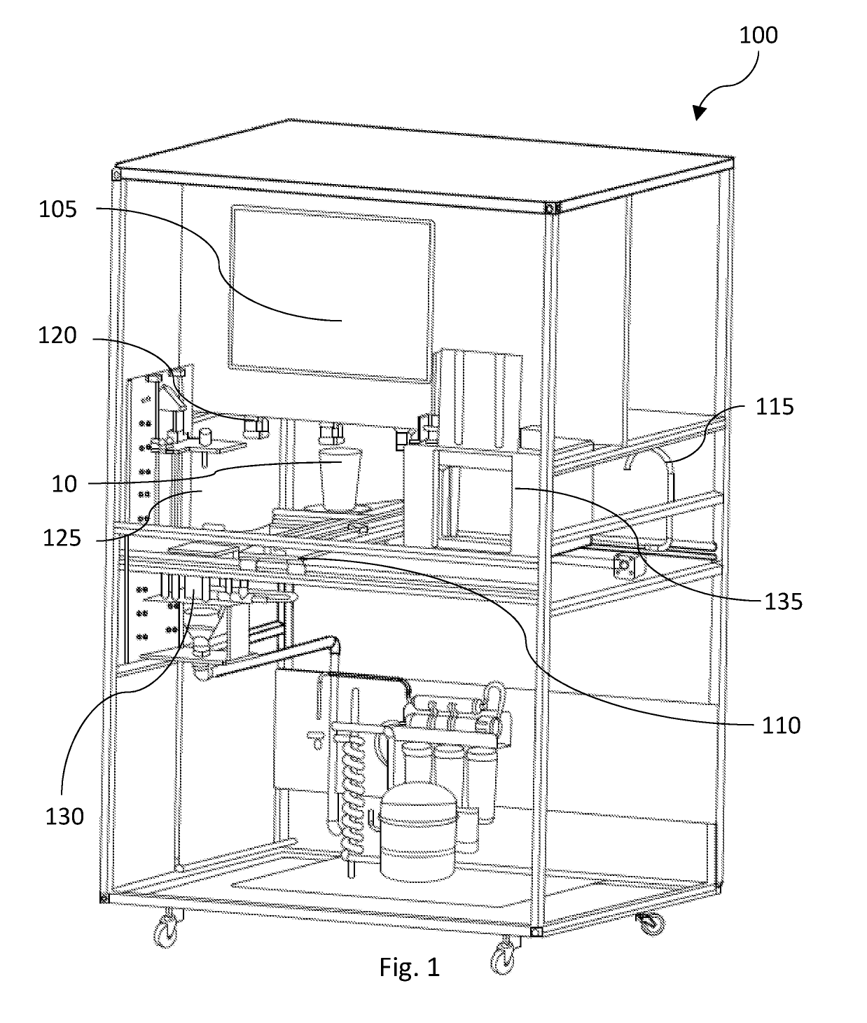

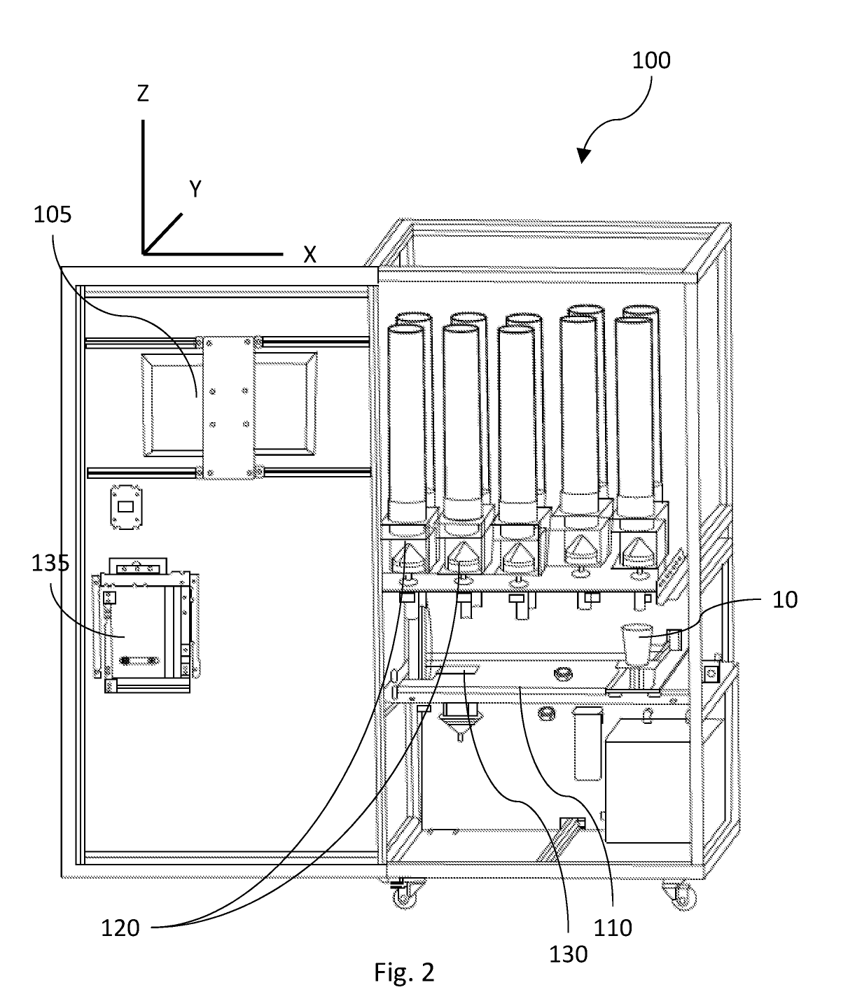

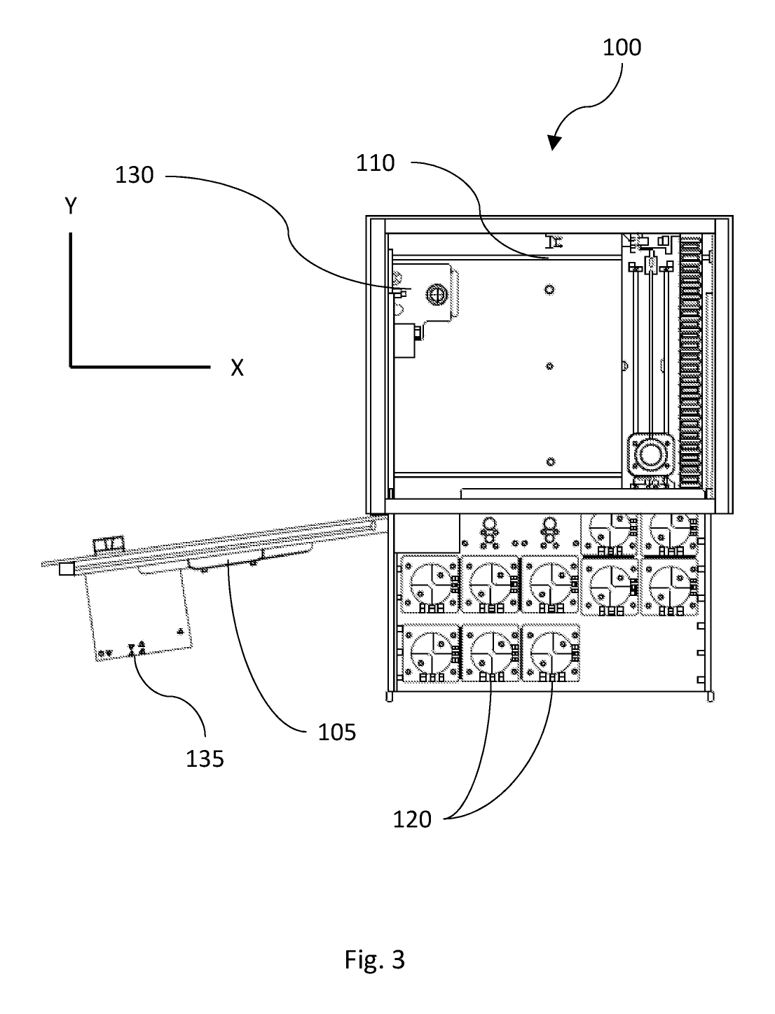

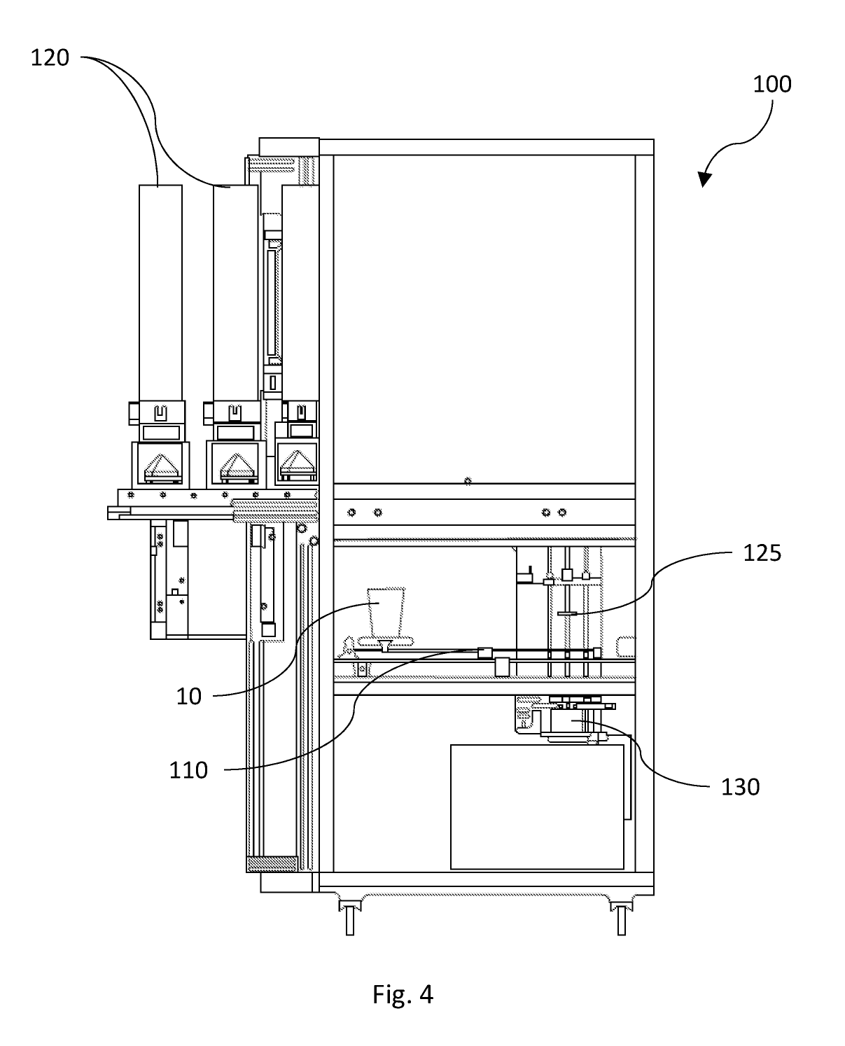

FIG. 1 is a perspective view of an exemplary automated vending machine 100 in accordance with certain aspects of the present disclosure. FIG. 2 is a perspective view of the exemplary automated vending machine 100 in accordance with certain aspects of the present disclosure. FIG. 3 is top elevational view of the exemplary automated vending machine 100 in accordance with certain aspects of the present disclosure. FIG. 4 is a side elevational view of the exemplary automated vending machine 100 in accordance with certain aspects of the present disclosure.

In some implementations, the automated vending machine 100 can include a user interface 105 with mechanical buttons or touch-screen based selection options, for providing instructions to the automated vending machine 100. The buttons can represent a type of drink/meal, an ingredient, a recipe, or the like. When a button is pressed, a command for a type of beverage or ingredient can be transmitted to a control computer. The control computer can interpret the commands to prepare the beverage.

In other implantations, the user interface 105 can be a touch screen configured to receive instructions from a user selecting a type of additive.

In other implementations, the can be received from an application on a mobile device via a WiFi, Bluetooth connection, or the like. Also, selections can be received from a website through a mobile device or a computer via wired or wireless communication.

In other implementations, the user can make a selection by scanning a bar code, a name of a drink/meal, a RFID tag, a quick response (QR) code, or the like.

A processor in the control computer of the automated vending machine 100 can be configured to transmit commands received from the user interface or remote computer to a container conveyor 110, a liquid station 115, an additive station 120, a blending station 125, a cleaning chamber 130, and a distribution station 135 to create the mixture in the container 10 according to the type of additive selected.

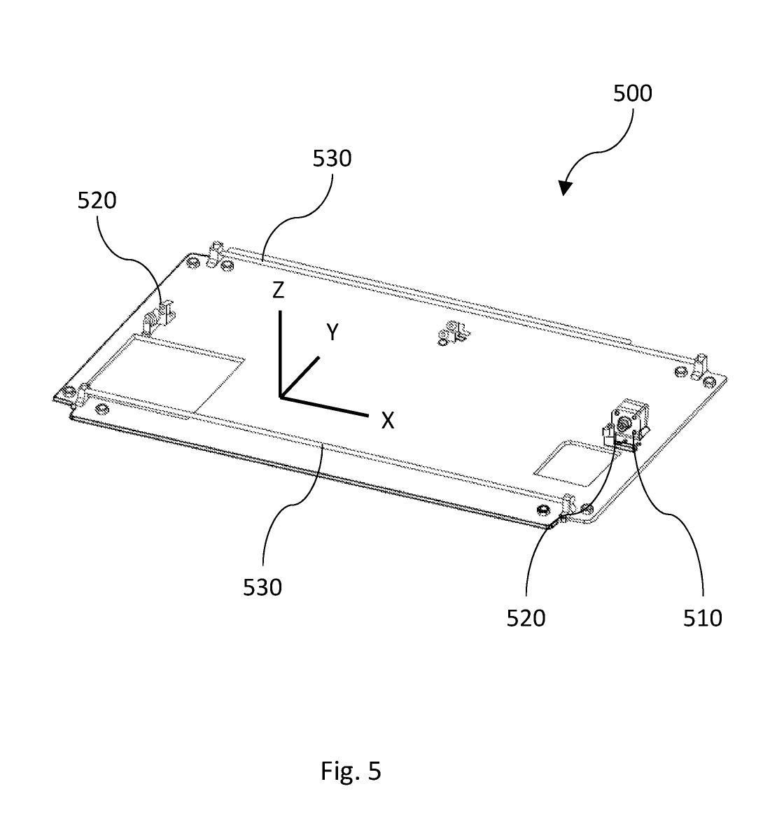

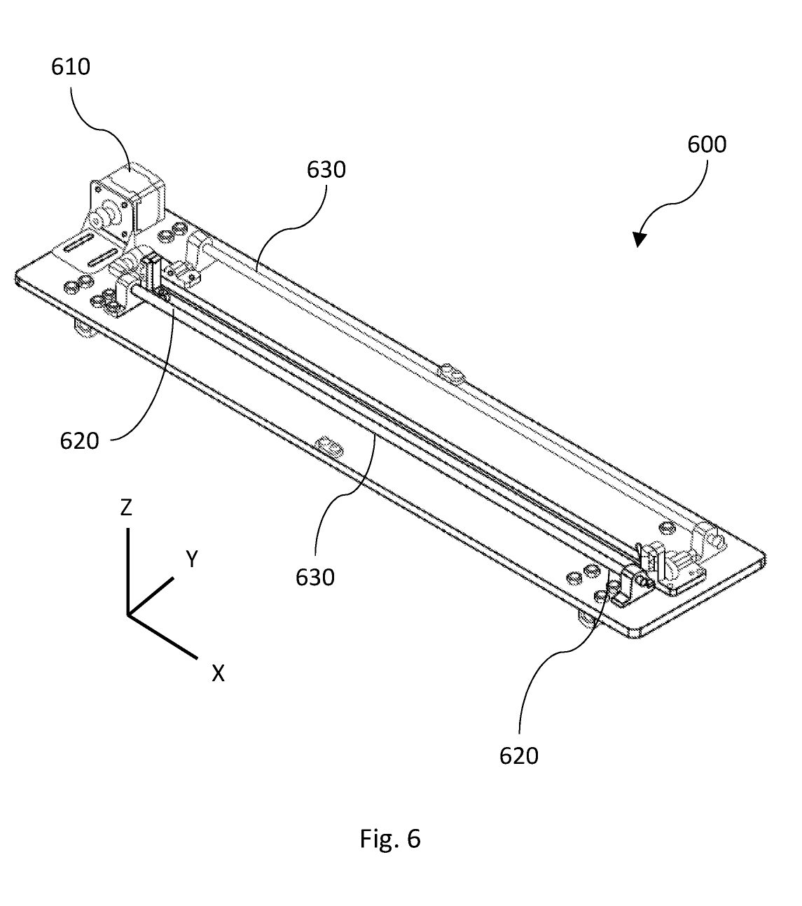

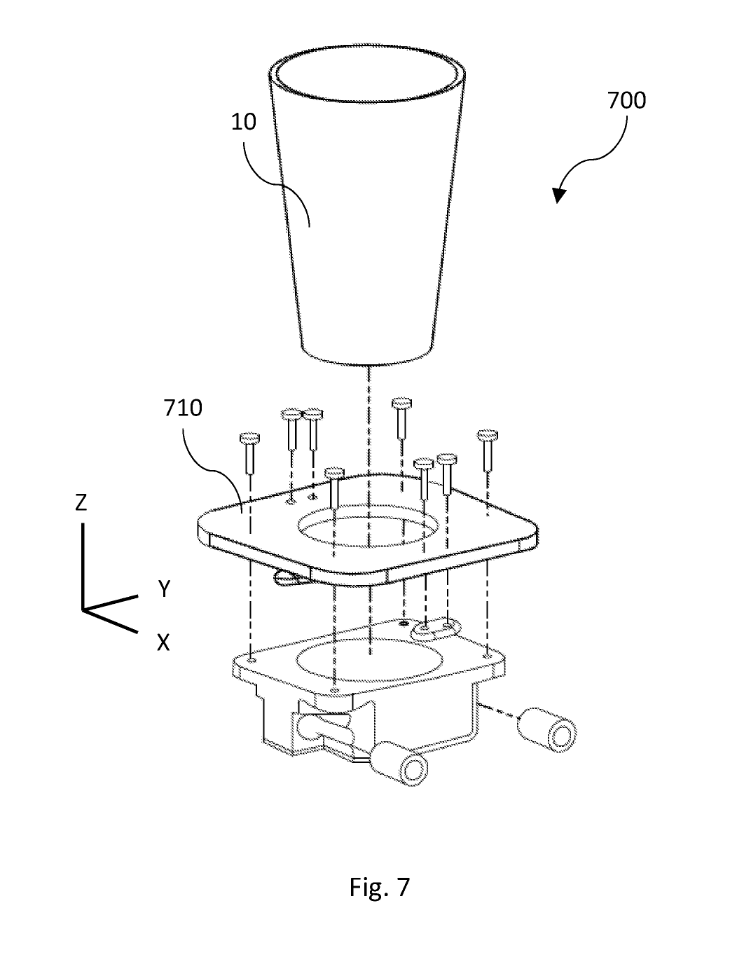

The automated vending machine 100 can include a container conveyor 110 configured to transport a container 10 to locations within the automated vending machine 100. The locations can include, for example, the liquid station 115, the additive station 120, and the distribution station 135. The container conveyor 110 can translate a container 10 between the stations during production of a mixture that is to be dispensed to a user. Once the container 10 is at the proper location, the ingredient can be vertically dispensed to the container 10. The container conveyor can include an X-axis shelf 500 (shown in FIG. 5), a Y-axis moving plate 600 (shown in FIG. 6), and a container holder 700 (shown in FIG. 7). There can be mechanical or optical sensors (or some other type of sensor) that can generate sensor data indicative of the position or orientation of the container 10 in the container conveyor 110. The sensor data can be compared with existing data to confirm that the container 10 is properly positioned in the container conveyor 110. Also, position sensors can be incorporated to track the motion or position of the X-axis shelf 500, Y-axis shelf 600, or the container holder 700. The position sensors can be, for example, accelerometers, gyroscopes, or the like. Signals received from the position sensors can be analyzed by the control computer to determine the current position in the automated vending machine 100.

FIG. 5 is a perspective view of an X-axis shelf 500 in accordance with certain aspects of the present disclosure. The X-axis shelf 500 translates the Y-axis moving plate 600 to move the container 10 to different X positions in the automated vending machine 100. In one implementation, the X-axis shelf 500 has an X-axis shelf drive motor 510 to rotate a drive mechanism. The X-axis shelf drive motor 510 can be operatively connected to, for example, a belt, screw drive, acme threaded rod, full threaded rod, linear rods, or the like, to achieve the motion of the Y-axis moving plate 600. The X-axis shelf drive motor 510 can be a stepper motor, servo, DC motor, or the like. There can also be limit switches 530 that limit the travel of the Y-axis moving plate 600 to avoid reaching the end of the threaded rod or hitting a motor or other component. The X-axis shelf 500 can include X-axis travel rods 530 that guide the motion of the Y-axis moving plate 600.

FIG. 6 is a perspective view of a Y-axis moving plate 600 in accordance with certain aspects of the present disclosure. In one implementation, the Y-axis moving plate 600 can be similar to the X-axis shelf 500 in that it can include a Y-axis drive motor 610 and Y-axis travel rods 630 to guide the motion of the container holder 700 in the Y direction. The Y-axis moving plate 600 can include X-axis linear bearings mounted to an underside of the Y-axis moving plate 600 and operatively connected to the X-axis travel rods 530. As with the X-axis shelf 500, the Y-axis drive motor 610 can be operatively connected to, for example, a belt, screw drive, acme threaded rod, full threaded rod, linear rods, or the like, to achieve the motion. Again, there can be limit switches 620 that limit the travel of the container holder 700 to avoid reaching the end of the threaded rod or hitting the Y-axis drive motor 610 or other component.

FIG. 7 is an exploded perspective view of container holder 700 in accordance with certain aspects of the present disclosure. The container holder 700 can include a receiving aperture 710 shaped to hold the container 10. In one implementation, the container holder 700 can travel along the guide rods of the Y-axis moving plate 600 by sliding along linear travel bearings. The motion of the container holder 700 is along the Y-axis moving plate 600, however, because the Y-axis moving plate 600 is coupled to the X-axis shelf 500, motion can be achieved on a 2-D plane in the automated vending machine 100. The Z position of the container 10 can be adjusted by the container holder 700 to accommodate different sizes of containers 10. In some implementations, the liquid stations 115 and additive stations 120 can be translated in the Z direction to accommodate different sizes of containers 10. In other implementations, the Y-axis moving plate 600 can be translated in the Z direction. The drive mechanism for the container holder 700, or any other translated component described herein, can be accomplished with, for example, a belt, screw drive, acme threaded rod, full threaded rod, linear rods, or the like.

Sensors, for example pressure sensors, optical sensors, or the like, can be incorporated to verify that the container 10 is properly positioned in the receiving aperture 710 before preparing the mixture. In implementations where containers are loaded by the automated vending machine 100, a container dispenser can be configured to release a container 10 into the receiving aperture 710 in response to received instructions from the control computer.

The liquid station 115 can include a liquid source configured to dispense a variable amount of a liquid to the container 10. As used herein, the liquid generally refers to the base of the mixture or beverage that can be made by the automated vending machine 100. Liquids can include, for example, a heated, refrigerated, frozen, or chilled liquid that can be water, milk, carbonated water, flavored liquid, or the like. In some implementations, water can be taken from an internal source or water line. Water can be filtered as it enters the automated vending machine 100 or can be a pre-filtered water source. The liquid source can also include any mechanical components required to dispense the liquid, for example, filters, pressurized tubes, supply containers, pumps, hoses, fasteners, sensors, or the like. The flow rate of the liquid can be regulated by the control computer.

In other implementations, during the cleaning cycle, any tubes that are used for dispensing perishable liquids (or additives) can be flushed with a sanitizing solution, water, or the like.

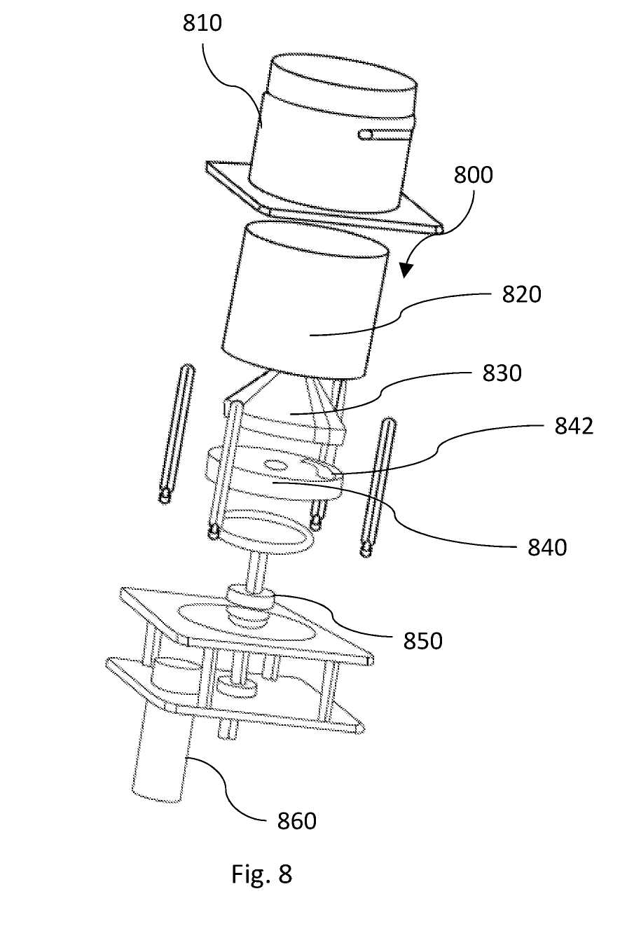

FIG. 8 is an exploded perspective view of an additive source 800 in accordance with certain aspects of the present disclosure. The additive source 800 can be operated to dispense a specific amount of additive to a container 10 when at the additive station 120. In one implementation, the additive source 800 can include a refill mounting system 810, a clear tube 820, an auger 830, a paddle dispensing wheel 840, a drive motor 850, and a flow tube 860. The refill mounting system 810 allows an additional additive to be added to the additive source 800. The additives (and liquids) can be heated, refrigerated, chilled, or frozen. Additives provided by any of the additive sources can include, for example, ice, protein powders, milk powders, chocolate powders, flavoring powders, or the like. In one implementation, the additive source 800 can include an ice machine that can make or deliver ice to the container 10.

The refill mounting system 810 can include a thread, lock, or other coupling mechanism to avoid spillage when refilling the additive supply 800. The additive can be transferred from the refill mounting system 810 to the clear tube 820. The clear tube 820 can be a glass or plastic transparent tube that can be visually inspected to verify the amount of additive present.

During operation, the auger 830 can guide an additive to the paddle dispensing wheel 840. The paddle dispensing wheel 840 can include a dispensing aperture 842 of variable width. The rate of additive dispensed can be controlled by rotating the paddle dispensing wheel 840 and the auger 830. The rotation can be enabled by a drive motor 850 operatively connected to the paddle dispensing wheel 840. The drive motor 850 can be similar to other drive motors described herein, utilizing belts, screws, stepper motors, or the like. When the additive source 800 includes an Archimedes screw or auger 830, a GT2, MXL, timing belt, or V-belt can be used to spin the Archimedes screw or auger 830. In another implementation, circular rods/gears or hex rods/gears can be used to spin the Archimedes screw or auger 830. The flow tube 860 can be a cylindrical tube that guides the additive from the additive source 800 to the container 10.

Sensors, for example, weight sensors, motion sensors, counters, or the like, can be implemented to control the amount of additive or liquid dispensed. In other implementations, infra-red (IR) sensors can be incorporated that measure rotation of the auger, the position of the auger 830 and/or paddle dispensing wheel 840, the number of times the paddle dispensing wheel 840 rotates and dispenses additive, or the like.

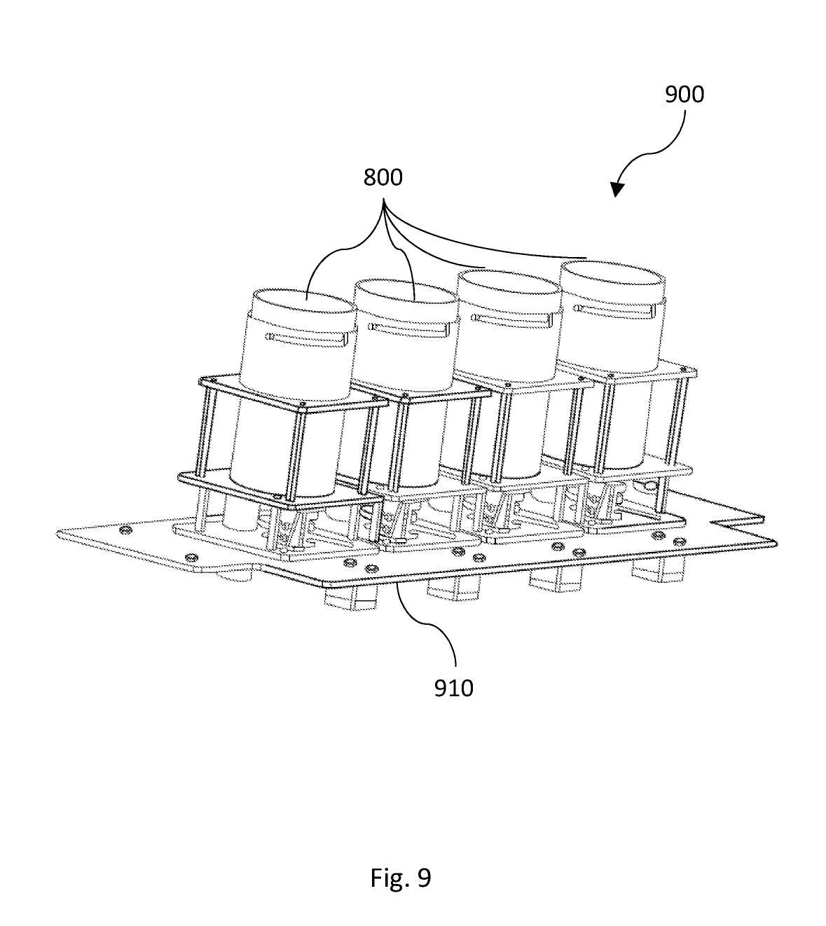

FIG. 9 is a perspective view of an additive source array 900 in accordance with certain aspects of the present disclosure. The additive source array 900 can include any number of additive sources. As shown in FIG. 3 and FIG. 9, any of the additive sources 800 can be operatively coupled to a sliding rack 910 that can extend out of the automated vending machine 100. In some implementations, the additive sources 800 can be vertically or horizontally removed and replaced. The additive sources 800 can also be refillable silos. The additive sources 800 can be sealed for transportation, and also include a mechanical seal which can be removed, replaced, or opened once the additive source 800 is placed in the automated vending machine 100.

Also, any of the motors described herein can incorporate or include a vibrating motor to vibrate a component coupled to the motor, for example the additive source 800 or the additive source array 900. In some implementations, the vibrating motor can be separate from the drive motor.

In other implementations, when the additive sources 900 return to the automated vending machine 100, a door can actuate to open and allow additive to be dispensed. Similarly, to avoid spillage, the door can be automatically closed when the sliding rack 910 is extended.

The distribution station 135 can be an area that can be accessible to a user and configured to receive the container 10. The distribution station 135 can be, for example, configured to receive a user-supplied container 10 and use this container 10 for preparation of the beverage. The distribution station 135 can also include one or more doors that can be automatically opened by the automated vending machine 100, or manually opened by a user, to place or receive the container 10 in the container conveyor 110.

Integrated with the distribution station 135, in some implementations, there can be sensors or interlocks that can require that a front door is closed before the container conveyor 110 begins movement. Similarly, other sensors or interlocks can confirm that a side door between the distribution station 135 and the interior of the automated vending machine 100 is open before the container conveyor 110 begins movement. Also, the side door can be controlled to remain closed until after the cleaning cycle is complete. The doors can be actuated by motors, or manually opened by a user. Once the mixture has been delivered to the distribution station 135, the front door can be automatically or manually opened to allow retrieval of the mixture by the user.

In another implementation, there can be a container extraction mechanism to extract the container 10 from the automated vending machine 100. The container extraction mechanism can lift the cup out of the container holder 700 and move it out of the automated vending machine 100 to be retrieved by a user. In some implementations, the container extraction mechanism can move the container 10 out through the distribution station 135. In other implementations, the container extraction mechanism can move the container 10 out through another opening in the automated vending machine 10.

The container extraction mechanism can include, for example, a sliding plate coupled to a motor and drive mechanism, a claw that grasps the container 10 and extends outward, or the like. There can also be one or more doors that can be interlocked to allow access by the container extraction mechanism only when a container 10 is added or retrieved by a user from the automated vending machine 100.

In other implementations, the container 10 can be supplied by the automated vending machine 100 and delivered to the distribution station 135 by the container conveyor 110 when the mixture has been prepared. In this implementation, there can also be a container station that includes a container source. The container source can dispense bottles, cups, bowls, or the like, to the container conveyor 110.

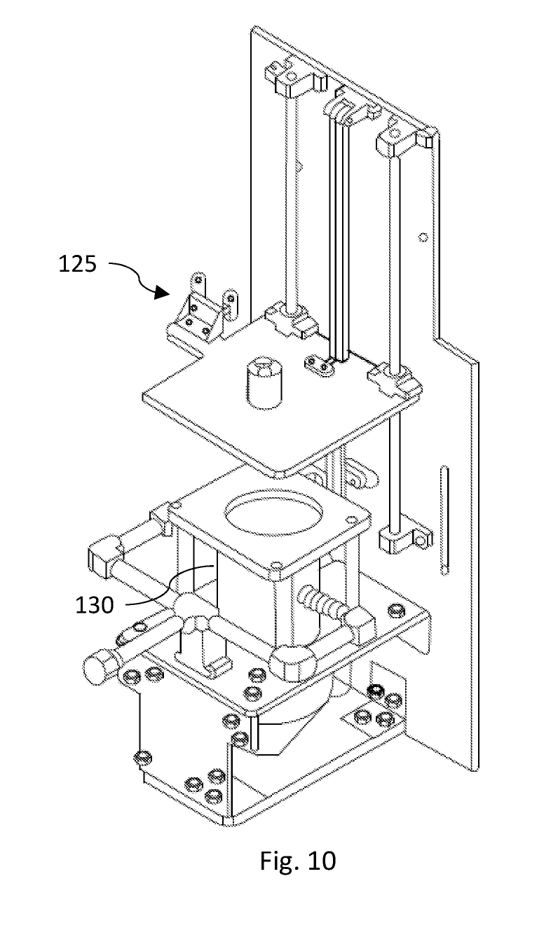

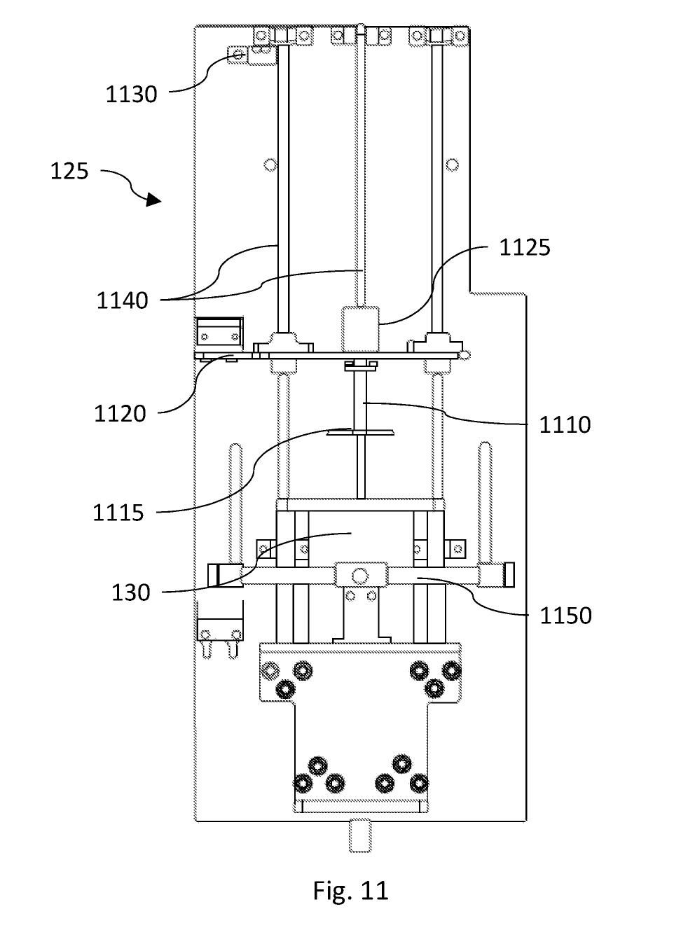

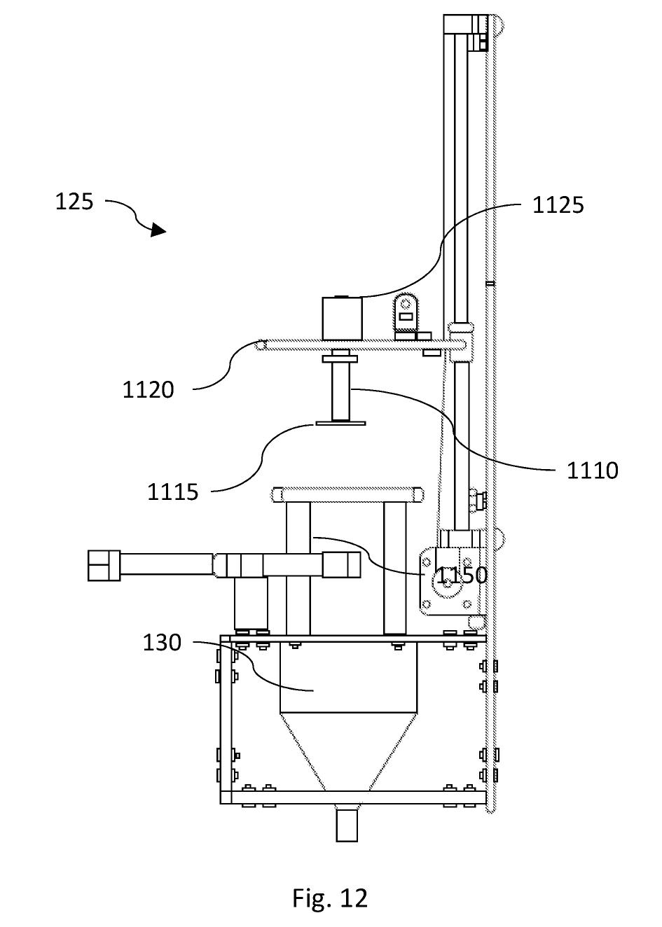

FIG. 10 is a perspective view of a blending station 125 and cleaning chamber 130 in accordance with certain aspects of the present disclosure. FIG. 11 is a front elevational view of the blending station 125 and cleaning chamber 130 in accordance with certain aspects of the present disclosure. FIG. 12 is a side elevational view of the blending station 125 and cleaning chamber 130 in accordance with certain aspects of the present disclosure.

The blending station 125 can be where the liquid and any additives in the container 10 can be blended to form a mixture that comprises the beverage. In particular, as shown in FIGS. 1-4, the blending station 125 can be separate from the liquid station 115, the additive station 120, and the distribution station 135.

The blending station 125 can include a blending mechanism 1110 configured to blend, in the container 10, the liquid and the additive to form the mixture. The blending mechanism 1110 can include a blending element 1115, for example, blades, stirrers, spoons, wires, or the like, shaped to be inserted into the container 10 for blending the mixture. The blending mechanism 1110 can vertically translate the blending element 1115 into an interior region of the container 10 to blend the liquid and the additive to form the mixture. The blending mechanism 1110 can perform the insertion by translating the blending element 1115 in a generally vertical direction. The blending mechanism 1110 can raise and lower the blending element 1115 to allow clearance for the container 10 to be positioned under the blending element 1115 by the container conveyor 110. In the implementation shown in FIGS. 10-12, the blending mechanism 1110 can include a blending plate 1120, the blending element 1115 operatively connected to the blending plate 1120, a blending plate drive mechanism, and limit switches 1130 operatively connected to the blending plate drive mechanism.

The blending plate 1120 can, for example, act as a support for holding the blending element 1115 a motor 1125 connected to the blending element 1115. The blending plate can translate in a generally vertical direction by the blending plate drive mechanism 1125.

The blending plate drive mechanism can include tracks, guide rods 1140, screw drives, conveyors, belts, or the like, that guide the motion of the blending plate. The blending plate drive mechanism 1125 can also include motors to move the blending plate with the belts, tracks, guides, or the like. The limit switches 1130 can act to disengage a motor at specified points in the travel of the blending plate 1120. A status (open/closed) of the limit switch can also be read by a control computer to communicate the location of the blending plate 120 and blending element 1115. The limit switches 1130 can also be used, for example, calibration, specifying home (or default) settings, setting machine axis limits, or the like.

The cleaning chamber 130 can include a cleaning mechanism 1150 configured to clean remains of the mixture from the blending mechanism 1110 and the cleaning chamber. As shown in FIG. 11, the blending station 125 can be vertically aligned with and separate from the cleaning chamber 130. The automated vending machine 100 can be configured to vertically translate the blending element 1115 to bring the blending element 1115 into the cleaning chamber 130.

The cleaning can occur, for example, before preparing the mixture, after preparing the mixture, at specified times programmed into the automated vending machine 100, as initiated by a user, or the like. For example, the cleaning process can be initiated after each blend, every other blend, every five blends, every hour, every two hours, every four hours, or at a specific time, such as noon, midnight, 6 am, or 6 pm.

As described herein, the cleaning can be applied to only a portion of the blending mechanism 1110, and not to every part of the cleaning mechanism 1110. For example, in one implementation, a lower surface of the blending plate 1120, a drive shaft for the cleaning element 1115, and the cleaning element 1115, can be the only portions of the blending mechanism 1110 that are cleaned by the cleaning mechanism 1150.

The cleaning chamber 130 can be shaped to receive the blending element 1115 when lowered into the cleaning chamber 130 by the blending plate drive mechanism 1125. This operation is described in further detail in the discussion of FIGS. 13-15. In other implementations, the cleaning chamber 130 can be lifted to the blending element 1115. The cleaning chamber 130 can include a cleaning solution source configured to deliver a cleaning solution to the cleaning chamber 130. Cleaning solution sources can include, for example, a pressurized water source, pressurized air source, a distilled water source, heated or chilled water, a dispenser, or the like. Cleaning solutions can include, for example, water, water containing soap or another cleaning additive, a cleaning agent, air, distilled water, or the like. In other implementations, the cleaning mechanism 1150 can be configured to clean remains of the mixture from an interior surface of the cleaning chamber 130. For example, if the blending element 1115 is turning during cleaning, some of the mixture remains may be ejected onto the inner walls of the cleaning chamber 130. The cleaning mechanism 1150 can spray or otherwise clean the walls to remove these remains.

Waste from the cleaning chamber 130 can be, for example, collected in a disposal chamber or routed to a drain. In some implementations, the disposal chamber can be located underneath the cleaning chamber 130. Similarly, there can be other draining paths to collect any spilled material from elsewhere in the machine and direct it to the disposal chamber or to a drain.

In another implementation, the cleaning mechanism 1110 can also include an ultraviolet light (UV) source configured to expose the cleaning chamber and the blending mechanism 1110, including the blending element 1115, to ultraviolet light. The ultraviolet light source can include, for example, UV lamps, UV lasers, or the like.

FIG. 13 is a simplified diagram illustrating a container 10 at the blending station 125 in accordance with certain aspects of the present disclosure. FIG. 14 is a simplified diagram illustrating a blending element 1115 in the container 10 during the blending process in accordance with certain aspects of the present disclosure. FIG. 15 is a simplified diagram illustrating the blending element 1115 at a cleaning chamber 130 in accordance with certain aspects of the present disclosure.

As shown in FIG. 13, a container 10 can be positioned under the blending element 1115 mounted on the blending plate 1120. The blending plate 1120 is generally vertically aligned with the cleaning chamber. In some implementations, the blending plate 1120 can begin flush with or abutting a top edge or surface of the cleaning chamber 130. An instruction can be received, for example upon a user selecting a beverage, that causes the blending plate 1120 to move vertically upward until it reaches a top limit switch.

To blend the mixture in the container 10, as shown in FIG. 14, the blending mechanism 1110 can lower the blending plate 1120 and the blending element 1115 into the container 10 until the blending element 1115 is within the mixture. The position of the blending element 1115 in the container 10 can be determined according to a predefined setting implemented by the control computer, based on a known container configuration, sensor data showing the container 10 configuration, or the like. Once the blending element 1115 is in the mixture, the bleeding mechanism 1110 can proceed to blend the mixture to form the beverage. To allow the blended mixture to be retrieved from the blending station 125, the blending mechanism 1110 can vertically translate the blending mechanism 1110 upwards (to the top limit switch) to allow the container conveyor 110 to retract the container 10 from the blending station 125.

Then, as shown in FIG. 15, the blending mechanism 1110 can vertically translate the blending plate 1120 and blending element 1115 downwards (to a bottom limit switch) to bring the blending element 1115 into the cleaning chamber. The blending element 1115 can be spun during the cleaning process. The cleaning solution and/or ultraviolet light can be applied to the blending element 1115 by the cleaning mechanism and UV source to remove remains of the mixture. In some implementations, the UV source can provide the UV illumination for a preset amount of time, for example, 1 second, 5 seconds, 10 seconds, 30 seconds, 1 minute, 5 minutes, or the like. The cycle can be limited to only occur after the cleaning process, including the UV illumination, is complete.

FIG. 16 is a diagram illustrating operations of a computer-program product in accordance with certain aspects of the present disclosure.

At 1600, a user interface configured to receive instructions from a user can receive a selection of a type of beverage comprising a liquid and an additive.

The container conveyor 110 can be controlled to translate a container 10 to a liquid station 115, an additive station 120, and a blending station 125, during creation of the mixture according to the type of beverage selected. The controlling can include:

At 1610, first translating, with a container conveyor 110, a container 10 to a liquid station 115.

At 1620, first dispensing, with a liquid source, a liquid to the container 10 in the liquid station 115.

At 1630, second translating, with the container conveyor 110, the container 10 to an additive station 120.

At 1640, second dispensing, with an additive source 800, an additive to the container 10 in the additive station 120.

At 1650, third translating, with the container conveyor 110, the container 10 to a blending station 125.

At 1660, blending, with a blending element 1115 operatively connected to a blending mechanism 1110 in the blending station 125, the liquid and the additive to form a mixture.

At 1670, the blending element 1115 can be cleaned with a cleaning mechanism 1150 in a cleaning chamber 130.

In some implementations, the control computer (or any computer connected to the automated vending machine 100), can track health data of a user and incorporate the health data into operation of the automated vending machine 100. Health data can include, for example, weight, BMI, fitness ability, fitness goals (lean, bulk up, cardio heavy), height, gender, exercise history, or the like. For example, in one implementation, the automated vending machine 100 can receive health data for a user. The health data can be manually entered by the user with the user interface 105, downloaded from another computer, measured by a sensor proximate to the automated vending machine 100, or the like. The health data can be recorded in a personal fitness account either in a memory of the automated vending machine 100 or stored in a remote computer or database. The personal fitness account can be viewed or modified through an application executed on a mobile device, website, or on the automated vending machine 100.

A beverage selection program can determine, based on the stored beverage selections and the health data, one or more types of beverages to present to a user at a display device. The user can then select a beverage from the one or more types for the automated vending machine 100 to prepare. In other implementations, any type of available beverage can be selected, regardless of the recommendation made by the beverage selection program. The amount of the mixture to be prepared can also be determined by a user or pre-selected. Amounts can be, for example, 4 oz, 8, oz, 12 oz, 16 oz, 20 oz, 25 oz, any amount between 4 oz and 25 oz, less than 4 oz, or greater than 25 oz. Similarly, the automated vending machine 100 can allow the user to select any amount of additive to include, for example, 0.5 servings, 1 serving, 2 servings, 4 servings, or the like. The beverage selection can be tracked over time by analyzing prior selections stored in the personal fitness account or other associated database.

The personal fitness account can also include a rewards program. The rewards program can provide a reusable cup with or without a top after 6 purchases (or any number of purchases). Then, the user can redeem a free beverage at the automated vending machine 100 after every 9 purchases (or any other number of purchases).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. The implementations described above can be directed to various combinations and subcombinations of the disclosed features and/or combinations and subcombinations of further features noted above. Furthermore, above described advantages are not intended to limit the application of any issued claims to processes and structures accomplishing any or all of the advantages.

Additionally, section headings shall not limit or characterize the invention(s) set out in any claims that may issue from this disclosure. Specifically, and by way of example, although the headings refer to a “Technical Field,” such claims should not be limited by the language chosen under this heading to describe the so-called technical field. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

What is claimed is:

1. An apparatus comprising:
a container conveyor configured to transport a container to a plurality of locations within the apparatus, the locations comprising:
a liquid station comprising a liquid source configured to dispense a liquid to the container;
an additive station comprising an additive source configured to dispense an additive to the container;
a distribution station accessible to a user and configured to receive the container; and
a blending station separate from the liquid station, the additive station, and the distribution station, the blending station comprising:
a blending mechanism configured to blend, in the container, the liquid and the additive to form a mixture; and
a cleaning chamber comprising a cleaning mechanism configured to clean remains of the mixture from the blending mechanism and the cleaning chamber.

2. The apparatus of claim 1, the cleaning mechanism further comprising a cleaning solution source configured to deliver a cleaning solution to the cleaning chamber.

3. The apparatus of claim 1, the cleaning mechanism further comprising an ultraviolet light source configured to expose the blending mechanism to ultraviolet light.

4. The apparatus of claim 1, the blending mechanism further comprising a blending element shaped to be inserted into the container for blending the mixture.

5. The apparatus of claim 1, wherein the container conveyor is configured to move the container on a horizontal plane connecting the locations.

6. The apparatus of claim 1, wherein the cleaning mechanism is further configured to clean remains of the mixture from an interior surface of the cleaning chamber.

7. The apparatus of claim 1, the blending mechanism configured to vertically translate a blending element to bring the blending element into an interior region of the container during blending.

8. The apparatus of claim 1, wherein the blending station is vertically aligned with and separate from the cleaning chamber, and
wherein the apparatus is configured to vertically translate the blending element to bring the blending element into the cleaning chamber.

9. The apparatus of claim 1, wherein the additive is a powder.

10. The apparatus of claim 1, wherein the liquid is water.

11. The apparatus of claim 1, further comprising a user interface configured to receive instructions from a user selecting a type of additive, wherein a processor in the apparatus is configured to transmit commands to the container conveyor, the liquid station, the additive station, and the blending station to create the mixture according to the type of additive selected.

12. A method comprising:
first translating, with a container conveyor, a container to a liquid station;
first dispensing, with a liquid source, a liquid to the container in the liquid station;
second translating, with the container conveyor, the container to an additive station;
second dispensing, with an additive source, an additive to the container in the additive station;
third translating, with the container conveyor, the container to a blending station;
blending, with a blending element operatively connected to a blending mechanism in the blending station, the liquid and the additive to form a mixture; and
cleaning, with a cleaning mechanism in a cleaning chamber, the blending element.

13. The method of claim 12, further comprising:
exposing the blending mechanism to ultraviolet light from an ultraviolet light source in the cleaning mechanism.

14. The method of claim 12, further comprising:
inserting a blending element, operatively connected to the blending mechanism, into the container; and
blending the mixture in the container with the blending element.

15. The method of claim 12, wherein the translating is on a horizontal plane connecting the locations.

16. The method of claim 12, further comprising:
vertically translating the blending element to bring the blending element into the cleaning chamber; and
cleaning an interior surface of the blending station and the blending element with the cleaning mechanism.

17. The method of claim 12, further comprising:
vertically translating the blending element to bring the blending element into an interior region of the container during blending.

18. A computer program product comprising a non-transient, machine-readable medium storing instructions which, when executed by at least one programmable processor, cause the at least one programmable processor to perform operations comprising:
receiving, from a user interface configured to receive instructions from a user, a selection of a type of beverage comprising a liquid and an additive;
controlling the container conveyor to translate a container to a liquid station, an additive station, and a blending station, during creation of the mixture according to the type of beverage selected, the controlling comprising:
first translating, with a container conveyor, a container to a liquid station;
first dispensing, with a liquid source, a liquid to the container in the liquid station;
second translating, with the container conveyor, the container to an additive station;
second dispensing, with an additive source, an additive to the container in the additive station;
third translating, with the container conveyor, the container to a blending station; and
blending, with a blending element operatively connected to a blending mechanism in the blending station, the liquid and the additive to form a mixture; and
cleaning, with a cleaning mechanism in a cleaning chamber, the blending element.

19. The computer program product of claim 18, the cleaning further comprising:
vertically translating a blending element, operatively connected to a cleaning mechanism, to bring the blending element into a cleaning chamber; and
cleaning the blending element and an interior surface of the cleaning chamber with the cleaning mechanism, the cleaning mechanism comprising a pressurized water source.

20. The computer program product of claim 19, the cleaning further comprising:
exposing the blending mechanism to ultraviolet light from an ultraviolet light source in the cleaning mechanism.
